(19) United States
(12) Patent Application Publication
(10) Pub. No.: US 2017/0269306 A1
(43) Pub. Date: Sep. 21, 2017

(54) FIBER OPTIC FERRULE ASSEMBLY AND METHOD OF MANUFACTURING THE SAME

(71) Applicant: ADC Telecommunications (Shanghai) Distuibution Co., Ltd., Shanghia (CN)

(72) Inventors: Zhaoyang TONG, Shanghai (CN); Longzhou QI, Shanghai (CN); Lei LIU, Shanghai (CN); Xingjun CHENG, Shanghai (CN)

(21) Appl. No.: 15/505,829

(22) PCT Filed: Aug. 17, 2015
(86) PCT No.: PCT/IB2015/056241

§ 371 Date: Feb. 22, 2017

(30) Foreign Application Priority Data
Aug. 22, 2014 (CN) 201410418211.7

(51) Int. Cl. G02B 6/38; B28B 1/24; B29D 11/00; B29C 45/14; B29C 45/00

(52) U.S. Cl. CPC G02B 6/3861; G02B 6/3865; B29C 45/14426; B29C 45/0053; B29C 45/14467; B29D 11/00663; B28B 1/24; B29K 2995/0012

(57) ABSTRACT

A fiber optic ferrule assembly is provided, which comprises a ferrule and an optical fiber received in the ferrule. The ferrule and the optical fiber are directly joined together, so as to fix the optical fiber in the ferrule. At least a part of the ferrule is directly over-molded on the optical fiber by injection molding or shrunk on the optical fiber. In the embodiments of the present invention, the ferrule is directly over-molded or shrunk on the optical fiber, so that the ferrule and the optical fiber are directly joined together. As a result, the optical fiber is stably fixed in the ferrule.

### CROSS-REFERENCE TO RELATED APPLICATION

This application claims the benefit of Chinese Patent Application No. 201410418211.7 filed on Aug. 22, 2014 in the State Intellectual Property Office of China, the whole disclosure of which is incorporated herein by reference.

### BACKGROUND OF THE INVENTION

Field of the Invention

Embodiments of the present invention relate to a fiber optic ferrule assembly and a method of manufacturing the fiber optic ferrule assembly.

Description of the Related Art

Generally, a fiber optic connector comprises a housing and a fiber optic ferrule assembly mounted in the housing. The fiber optic ferrule assembly mainly comprises a ferrule and one or more fibers received in one or more bores formed in the ferrule.

In prior art, an adhesive for fixing the fiber in the bore of the ferrule is poured into the bore of the ferrule before inserting the fiber into the bore of the ferrule. After the adhesive (for example, an epoxy adhesive widely used in optical fiber connector industry) is cured (for example, by heating), the fiber is fixed in the bore of the ferrule. After that, the optical fiber ferrule assembly is polished, so as to complete the manufacture of the optical fiber ferrule assembly.

In the above solution of manufacturing the fiber optic ferrule assembly, the manufacturing process is complex, and it needs to pour the adhesive into the bore of the ferrule, then insert the fiber through the bore in which the adhesive has been poured, and then cure the adhesive. Especially for the epoxy adhesive widely used in the fiber optic connector industry, it needs to spend a lot of time curing it, lowering the production efficiency. The adhesive is adhered onto the fiber optic ferrule assembly, and it needs to remove the adhesive adhered onto the ferrule and the front end of the fiber, which results in increasing the manufacturing difficulty, reducing the manufacturing efficiency, and decreasing the optical properties of the fiber optic connector. The performance of the adhesive, for fixing the fiber in the bore of ferrule, will become degrading in a limiting temperature, which leads to the degradation of the optical performance and the reliability of the fiber optic connector.

### SUMMARY OF THE INVENTION

The present invention has been made to overcome or alleviate at least one aspect of the above mentioned disadvantages.

According to an object of the present invention, there is provided a method of manufacturing a fiber optic ferrule assembly, which increases the production efficiency of the fiber optic ferrule assembly. According to another object of the present invention, there is provided a fiber optic ferrule assembly and a method of manufacturing the fiber optic ferrule assembly, which improves the optical performance of the fiber optic ferrule assembly.

According to an aspect of the present invention, there is provided a fiber optic ferrule assembly comprising a ferrule and an optical fiber received in the ferrule, wherein the ferrule and the optical fiber are directly joined together, so as to fix the optical fiber in the ferrule.

According to an exemplary embodiment of the present invention, at least a part of the ferrule is directly over-molded on the optical fiber by injection molding, so that the ferrule and the optical fiber are directly joined together.

According to another exemplary embodiment of the present invention, the ferrule comprises: a ferrule body having an end projection formed on a front end surface thereof; and an end cover directly over-molded on the end projection and the optical fiber protruding from a front end of the end projection by injection molding.

According to another exemplary embodiment of the present invention, a bore is formed in the ferrule body, and the optical fiber is inserted through the bore and protrudes from the front end of the end projection.

According to another exemplary embodiment of the present invention, at least one circumferential groove is formed in the end projection; and the end projection is covered by the end cover, and a portion of the end cover is embedded into the circumferential groove, so as to secure the end cover onto the end projection and prevent the end cover from being disengaged from the end projection.

According to another exemplary embodiment of the present invention, at least one axial groove is formed in the end projection; and a portion of the end cover is embedded into the axial groove, so as to prevent the end cover from being rotated with respect to the end projection.

According to another exemplary embodiment of the present invention, the ferrule body is made of a material having stable chemical and structural properties, for example, ceramic or plastic or any other suitable material.

According to another exemplary embodiment of the present invention, the end cover is made of a material having a thermal expansion coefficient approximate to that of a material forming the optical fiber.

According to another exemplary embodiment of the present invention, the end cover is formed with a first tapered peripheral surface; the front end of the ferrule body is formed with a second tapered peripheral surface; and the first tapered peripheral surface has a taper equal to that of the second tapered peripheral surface.

According to another exemplary embodiment of the present invention, the end cover is formed with a first tapered peripheral surface; the front end of the ferrule body is formed with a second tapered peripheral surface; and the first tapered peripheral surface has a taper different from that of the second tapered peripheral surface.

According to another exemplary embodiment of the present invention, the ferrule comprises: a ferrule body; and a ferrule end portion adhered to a front end surface of the ferrule body, wherein the ferrule end portion is directly over-molded on the optical fiber by injection molding, and the optical fiber is inserted through a bore formed in the ferrule body.

According to another exemplary embodiment of the present invention, the ferrule end portion is made of a material having a thermal expansion coefficient approximate to that of a material forming the optical fiber.

According to another exemplary embodiment of the present invention, wherein the entire ferrule is directly over-molded on the optical fiber by injection molding.

According to another exemplary embodiment of the present invention, the ferrule is made of a material having a thermal expansion coefficient approximate to that of a material forming the optical fiber.

According to another exemplary embodiment of the present invention, the ferrule comprises: an inner body directly over-molded on the optical fiber by injection molding; and an outer body directly over-molded on the inner body by injection molding.

According to another exemplary embodiment of the present invention, the inner body is made of a material having a thermal expansion coefficient approximate to that of a material forming the optical fiber.

According to another exemplary embodiment of the present invention, at least a part of the ferrule is directly shrunk on the optical fiber, so that the ferrule and the optical fiber are directly joined together.

According to another exemplary embodiment of the present invention, the entire ferrule is directly shrunk on the optical fiber.

According to another exemplary embodiment of the present invention, the ferrule is made of a material having a thermal expansion coefficient approximate to that of a material forming the optical fiber.

According to another exemplary embodiment of the present invention, the ferrule comprises: an inner body directly over-molded on the optical fiber by injection molding; and an outer body directly shrunk on the inner body.

According to another exemplary embodiment of the present invention, the inner body is made of a material having a thermal expansion coefficient approximate to that of a material forming the optical fiber.

According to another exemplary embodiment of the present invention, the ferrule is a single fiber optic ferrule, a multi-fiber optic ferrule, a single mode fiber optic ferrule or a multi-mode fiber optic ferrule.

According to another aspect of the present invention, there is provided a method of manufacturing the fiber optic ferrule assembly, comprising steps of:

S100: directly over-molding at least a part of a ferrule onto an optical fiber by injection molding, so that the ferrule and the optical fiber are directly joined together to form the fiber optic ferrule assembly.

According to an exemplary embodiment of the present invention, the step S100 comprises:

S111: forming a ferrule body having a bore therein and an end projection on a front end surface thereof;

S112: inserting an optical fiber into the bore of the ferrule body until the optical fiber is protruded from a front end of the end projection;

S113: directly over-molding an end cover on the end projection and the optical fiber protruding from the front end of the end projection by injection molding; and

S114: processing the ferrule and the optical fiber.

According to another exemplary embodiment of the present invention, at least one circumferential groove is formed in the end projection; and the end projection is covered by the end cover, and a portion of the end cover is embedded into the circumferential groove, so as to secure the end cover onto the end projection and prevent the end cover from being disengaged from the end projection.

According to another exemplary embodiment of the present invention, at least one axial groove is formed in the end projection; and a portion of the end cover is embedded into the axial groove, so as to prevent the end cover from being rotated with respect to the end projection.

According to another exemplary embodiment of the present invention, the ferrule body may be made of a material having stable chemical and structural properties, for example, ceramic or plastic or any other suitable material.

According to another exemplary embodiment of the present invention, the end cover is made of a material having a thermal expansion coefficient approximate to that of a material forming the optical fiber.

According to another exemplary embodiment of the present invention, the end cover is formed with a first tapered peripheral surface; the front end of the ferrule body is formed with a second tapered peripheral surface; and the first tapered peripheral surface has a taper equal to that of the second tapered peripheral surface.

According to another exemplary embodiment of the present invention, the end cover is formed with a first tapered peripheral surface; the front end of the ferrule body is formed with a second tapered peripheral surface; and the first tapered peripheral surface has a taper different from that of the second tapered peripheral surface.

According to another exemplary embodiment of the present invention, the step 5100 comprises:

S121: directly over-molding a ferrule end portion on the optical fiber by injection molding;

S122: inserting the optical fiber through a bore formed in a ferrule body, and adhering the ferrule end portion onto a front end surface of the ferrule body; and

S123: processing the ferrule and the optical fiber.

According to another exemplary embodiment of the present invention, the ferrule end portion is made of a material having a thermal expansion coefficient approximate to that of a material forming the optical fiber.

According to another exemplary embodiment of the present invention, the step 5100 comprises:

S131: directly over-molding a preformed body on the optical fiber by injection molding, so as to obtain a preformed blank having a length larger than that of a single fiber optic ferrule assembly;

S132: cutting the preformed blank into one or more preformed blank sections with each having a length equal to that of the single fiber optic ferrule assembly;

S133: removing a portion of a body of the preformed blank section to expose a section of optical fiber, and using the rest of the body of the preformed blank section as the ferrule body; and

S134: cutting and polishing the ferrule body and the optical fiber, for example, cutting, polishing, applying energy (for example, applying laser or electric arc) or performing other suitable processes on the ferrule body and the optical fiber.

According to another exemplary embodiment of the present invention, the ferrule body is made of a material having a thermal expansion coefficient approximate to that of a material forming the optical fiber.

According to another exemplary embodiment of the present invention, the step 5131 comprises:

S1311: directly over-molding a preformed inner body on the optical fiber by injection molding; and

S1312: directly over-molding a preformed outer body on the preformed inner body by injection molding, so as to obtain the preformed blank having a length larger than that of the single fiber optic ferrule assembly.

According to another exemplary embodiment of the present invention, the preformed inner body is made of a material having a thermal expansion coefficient approximate to that of a material forming the optical fiber.

According to another exemplary embodiment of the present invention, the step 5100 comprising:

S141: directly over-molding a ferrule body on the optical fiber by injection molding; and

S142: processing the ferrule body and the optical fiber, for example, cutting, polishing, applying energy (for example, applying laser or electric arc) or performing other suitable processes on the ferrule body and the optical fiber.

According to another exemplary embodiment of the present invention, the ferrule body is made of a material having a thermal expansion coefficient approximate to that of a material forming the optical fiber.

According to another exemplary embodiment of the present invention, the step 5141 comprising:

S1411: directly over-molding a ferrule inner body on the optical fiber by injection molding; and

S1412: directly over-molding a ferrule outer body on the ferrule inner body by injection molding.

According to another exemplary embodiment of the present invention, the ferrule inner body is made of a material having a thermal expansion coefficient approximate to that of a material forming the optical fiber.

According to another aspect of the present invention, there is provided a method of manufacturing a fiber optic ferrule assembly, comprising steps of:

S200: directly shrinking at least a part of a ferrule on an optical fiber, so that the ferrule and the optical fiber are directly joined together to form the fiber optic ferrule assembly.

According to an exemplary embodiment of the present invention, the step 5200 comprises:

S211: inserting the optical fiber through a bore formed in a ferrule body;

S212: directly shrinking the ferrule body on the optical fiber; and

S213: processing the ferrule body and the optical fiber, for example, cutting, polishing, applying energy (for example, applying laser or electric arc) or performing other suitable processes on the ferrule body and the optical fiber.

According to another exemplary embodiment of the present invention, before shrinking the ferrule body, the bore of the ferrule body has a diameter larger than that of the optical fiber.

According to another exemplary embodiment of the present invention, the ferrule body is made of a material having a thermal expansion coefficient approximate to that of a material forming the optical fiber.

According to another aspect of the present invention, there is provided a method of manufacturing a fiber optic ferrule assembly, comprising steps of:

S311: directly over-molding a ferrule inner body on an optical fiber by injection molding;

S312: inserting the ferrule inner body and the optical fiber through a hole formed in a ferrule outer body;

S313: directly shrinking the ferrule outer body on the ferrule inner body; and

S314: processing the ferrule body and the optical fiber, for example, cutting, polishing, applying energy (for example, applying laser or electric arc) or performing other suitable processes on the ferrule body and the optical fiber.

According to an exemplary embodiment of the present invention, a front end surface of the ferrule inner body is flush with a front end surface of the ferrule outer body; or a front end surface of the ferrule inner body is protruded from a front end surface of the ferrule outer body; or a front end surface of the ferrule inner body is recessed into the ferrule outer body.

According to another exemplary embodiment of the present invention, before shrinking the ferrule outer body, the hole of the ferrule outer body has a diameter larger than an outer diameter of the ferrule inner body.

According to another exemplary embodiment of the present invention, the ferrule inner body is made of a material having a thermal expansion coefficient approximate to that of a material forming the optical fiber.

According to another aspect of the present invention, there is provided a method of manufacturing a fiber optic ferrule assembly, comprising steps of:

S321: inserting an optical fiber through a bore formed in a ferrule inner body;

S322: directly shrinking the ferrule inner body on the optical fiber;

S323: directly over-molding a ferrule outer body on the ferrule inner body by injection molding; and

S324: processing the ferrule body and the optical fiber, for example, cutting, polishing, applying energy (for example, applying laser or electric arc) or performing other suitable processes on the ferrule body and the optical fiber.

According to another exemplary embodiment of the present invention, before shrinking the ferrule inner body, the bore of the ferrule inner body has a diameter larger than that of the optical fiber.

According to another exemplary embodiment of the present invention, the ferrule inner body is made of a material having a thermal expansion coefficient approximate to that of a material forming the optical fiber.

According to another exemplary embodiment of the present invention, the ferrule is a single fiber optic ferrule, a multi-fiber optic ferrule, a single mode fiber optic ferrule or a multi-mode fiber optic ferrule.

According to another aspect of the present invention, there is provided a fiber optic connector, which comprises: a housing; and the fiber optic ferrule assembly, according to any one of above embodiments or made by the method according to any one of above embodiments, mounted in the housing.

In the above various embodiments of the present invention, the ferrule is directly over-molded or shrunk on the optical fiber and directly joined to the optical fiber. As a result, the optical fiber is stably fixed in the ferrule. The solution of the present invention greatly increases the production efficiency of the fiber optic ferrule assembly and improves the optical performance of the fiber optic ferrule assembly.

Embodiments of the present invention propose a novel method of manufacturing the fiber optic ferrule assembly. In the present invention, the ferrule and the optic fiber of the fiber optic ferrule assembly are directly joined together, instead of fixing the optical fiber in the ferrule by the adhesive. Thereby, it saves many steps of: manufacturing an individual ferrule, pouring the adhesive into the bore of the ferrule, inserting the optical fiber through the bore of the ferrule, heating the ferrule to cure the adhesive, and so on. Thereby, it effectively increases the production efficiency of the fiber optic ferrule assembly and reduces the cost of the fiber optic connector. In the above various embodiments of the present invention, since it does not use the adhesive or other adhesive material to fix the optical fiber into the ferrule, the end surface of the ferrule is very clean, simplifying the machining process and improving the product reliability. Meanwhile, the optical fiber and ferrule are directly joined together, the ferrule is made of material with high and stable physical and chemical properties, and the ferrule has a thermal expansion coefficient approximate to that of the optical fiber. In this way, the optical fiber ferrule assembly has a good stability and may work well in some harsh conditions, such as, in high power or high temperature.

### BRIEF DESCRIPTION OF THE DRAWINGS

The above and other features of the present invention will become more apparent by describing in detail exemplary embodiments thereof with reference to the accompanying drawings, in which:

FIG. 1 is an illustrative perspective view of a ferrule body of a fiber optic ferrule assembly according to a first embodiment of the present invention;

FIG. 2 is a schematic view of the ferrule body of FIG. 1 after inserting an optical fiber through a bore thereof;

FIG. 3 is a schematic view showing an end cover formed on an end projection of the ferrule body and the optical fiber of FIG. 2;

FIG. 4 is a cross section view of a fiber optic ferrule assembly blank of FIG. 3;

FIG. 5 is a schematic view of a final fiber optic ferrule assembly formed by cutting and polishing the fiber optic ferrule assembly blank of FIG. 3;

FIG. 6 is a schematic view of another final fiber optic ferrule assembly formed by cutting and polishing the fiber optic ferrule assembly blank of FIG. 3;

FIG. 7 is a schematic view of an optical fiber and a ferrule end portion directly molded on the optical fiber of a fiber optic ferrule assembly according to a second embodiment of the present invention;

FIG. 8 is a schematic view showing the optical fiber of FIG. 7 inserting through a bore of the ferrule body and the ferrule end portion adhering onto the ferrule body;

FIG. 9 is a schematic view of a final fiber optic ferrule assembly formed by cutting and polishing the fiber optic ferrule assembly blank of FIG. 8;

FIG. 10 is a schematic view of a fiber optic ferrule assembly according to a third embodiment of the present invention, in which a preformed body is directly molded on an optical fiber;

FIG. 11 is a schematic view showing a preformed inner body directly molded on the optical fiber according to an exemplary embodiment of the present invention;

FIG. 12 is a schematic view showing a preformed outer body directly molded on the inner body of FIG. 11;

FIG. 13 is a schematic view of a preformed blank section by cutting the preformed blank into one or more preformed blank sections, with each having a length equal to that of the single fiber optic ferrule assembly;

FIG. 14 is a schematic view of the preformed blank section of FIG. 13, in which a portion of the preformed blank section is removed to expose the optical fiber;

FIG. 15 is a schematic view of a final fiber optic ferrule assembly formed by cutting and polishing the fiber optic ferrule assembly blank of FIG. 14;

FIG. 16 is a schematic view of a fiber optic ferrule assembly according to a fourth embodiment of the present invention, in which a ferrule body is directly molded on an optical fiber;

FIG. 17 is a schematic view showing a ferrule inner body directly molded on the optical fiber according to an exemplary embodiment of the present invention;

FIG. 18 is a schematic view of a ferrule outer body directly molded on the ferrule inner body of FIG. 17;

FIG. 19 is a schematic view of a final fiber optic ferrule assembly formed by cutting and polishing the fiber optic ferrule assembly blank of FIG. 16;

FIG. 20 is a schematic view of a fiber optic ferrule assembly according to a fifth embodiment of the present invention, in which the optical fiber is inserted through a bore formed in the ferrule body;

FIG. 21 is a schematic view showing the ferrule body shrunk on the optical fiber;

FIG. 22 is a schematic view of a final fiber optic ferrule assembly formed by cutting and polishing the fiber optic ferrule assembly blank of FIG. 21;

FIG. 23 is a schematic view of a fiber optic ferrule assembly according to a sixth embodiment of the present invention, in which the ferrule inner body is directly molded on the optical fiber;

FIG. 24 is a schematic view showing the ferrule inner body inserting through a hole formed in the ferrule outer body;

FIG. 25 is a schematic view showing the ferrule outer body shrunk on the ferrule inner body; and

FIG. 26 is a schematic view of a final fiber optic ferrule assembly formed by cutting and polishing the fiber optic ferrule assembly blank of FIG. 25.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a general concept of the present invention, there is provided a fiber optic ferrule assembly comprising a ferrule and an optical fiber received in the ferrule, wherein the ferrule and the optical fiber are directly joined together, so as to fix the optical fiber in the ferrule.

### First Embodiment

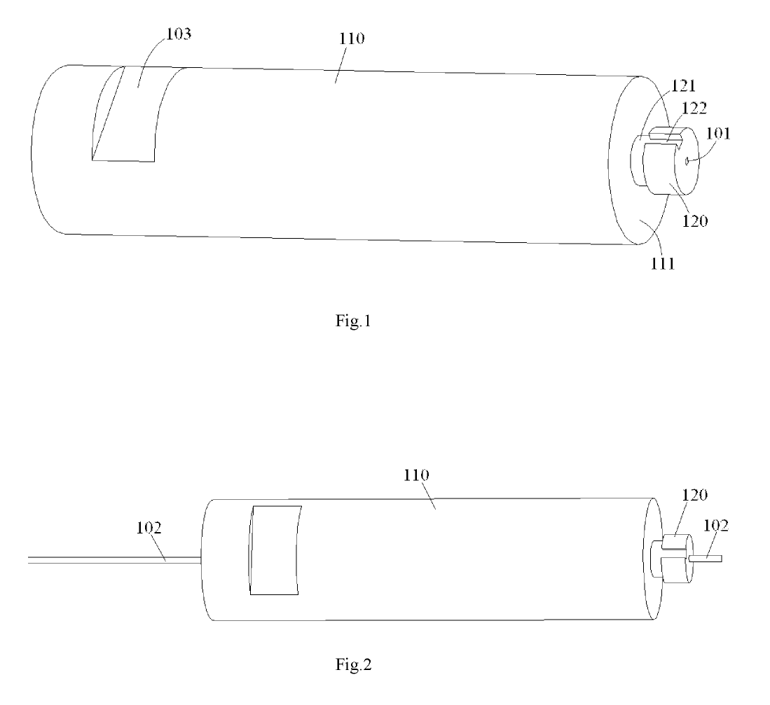

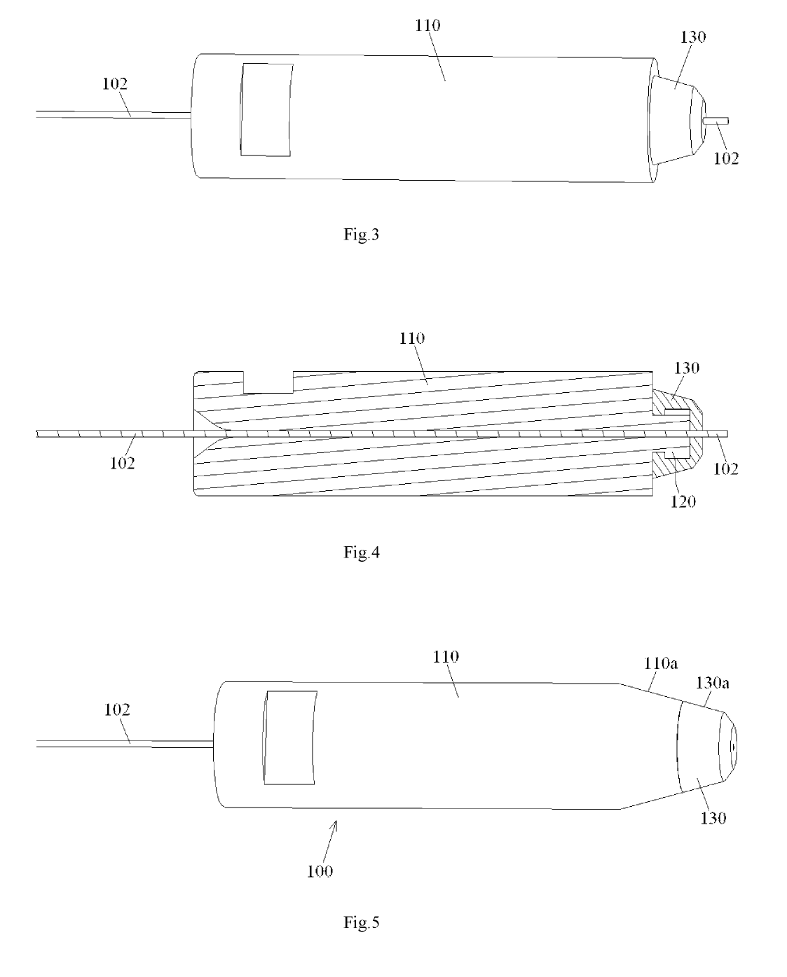

FIG. 1 is an illustrative perspective view of a ferrule body 110 of a fiber optic ferrule assembly 100 according to a first embodiment of the present invention; FIG. 2 is a schematic view of the fiber optic ferrule assembly 100 after inserting an optical fiber 102 through a bore 101 of the ferrule body 110 of FIG. 1; FIG. 3 is a schematic view of the fiber optic ferrule assembly 100 with an end cover 130 formed on an end projection 120 of the ferrule body 110 and the optical fiber 102; FIG. 4 is a cross section view of a blank of the fiber optic ferrule assembly of FIG. 3; FIG. 5 is a schematic view of a final fiber optic ferrule assembly 100 formed by cutting and polishing the blank of the fiber optic ferrule assembly of FIG. 3.

Hereafter, a method of manufacturing a fiber optic ferrule assembly according to the first embodiment of the present invention will be described with reference to FIGS. 1-5.

Firstly, as shown in FIG. 1, forming a ferrule body 110 by molding or machining. Referring to FIG. 1, the ferrule body 110 is formed with a bore 101 therein, an end projection 120 on a front end surface 111 thereof, and a recess 103, for fixing a ferrule seat (not shown), on a rear end circumferential surface thereof.

Then, as shown in FIG. 2, inserting an optical fiber 102 into the bore 101 of the ferrule body 110 until the optical fiber 102 is protruded from a front end of the end projection 120 by a predetermined distance;

Then, placing the ferrule body 110 and the optical fiber 102 into a molding die and injecting molten material into the molding die, so as to form an end cover 130 on the end projection 120 and the optical fiber 102 protruding from the front end of the end projection 120, that is, as shown in FIGS. 3-4, the end cover 130 is directly over-molded on the end projection 120 and the optical fiber 102 protruding from the front end of the end projection 120 by injection molding.

Finally, performing subsequent processes such as cutting, polishing or applying energy (applying laser or electric arc), on the ferrule body 110, the end cover 130 and the optical fiber 102, so that parameters such as the outer diameter and the cylindricity of the ferrule body 110, the concentricity between the optical fiber 102 and the outer cylindrical surface of the ferrule body 110, or the surface roughness of the ferrule body 110, conform to the current technical specification. In this way, a final fiber optic ferrule assembly 100 is formed based on the current technical specification, as shown in FIG. 5.

Referring to FIGS. 1-5 again, at least one circumferential groove 121 is formed in the end projection 120. The end projection 120 is covered by the end cover 130, and a portion of the end cover 130 is embedded into the circumferential groove 121, so as to secure the end cover 130 onto the end projection 120 and prevent the end cover 130 from being disengaged from the end projection 120.

Referring to FIGS. 1-5 again, at least one axial groove 122 is formed in the end projection 120. A portion of the end cover 130 is embedded into the axial groove 122, so as to prevent the end cover 130 from being rotated with respect to the end projection 120.

In an embodiment of the present invention, the ferrule body 110 may be made of ceramic, plastic, metal or any other suitable material.

In an embodiment of the present invention, the end cover 130 is made of a material having a thermal expansion coefficient equal to or approximate to that of a material forming the optical fiber 102.

As shown in FIG. 5, the end cover 130 is formed with a first tapered peripheral surface 130a; the front end of the ferrule body 110 is formed with a second tapered peripheral surface 110a; and the first tapered peripheral surface 130a has a taper equal to that of the second tapered peripheral surface 110a. As a result, a smooth transition is achieved between the second tapered peripheral surface 110a of the ferrule body 110 and the first tapered peripheral surface 130a of the end cover 130.

However, the present disclosure is not limited to the embodiment shown in FIG. 5, the final fiber optical ferrule assembly may have any other suitable shape or configuration.

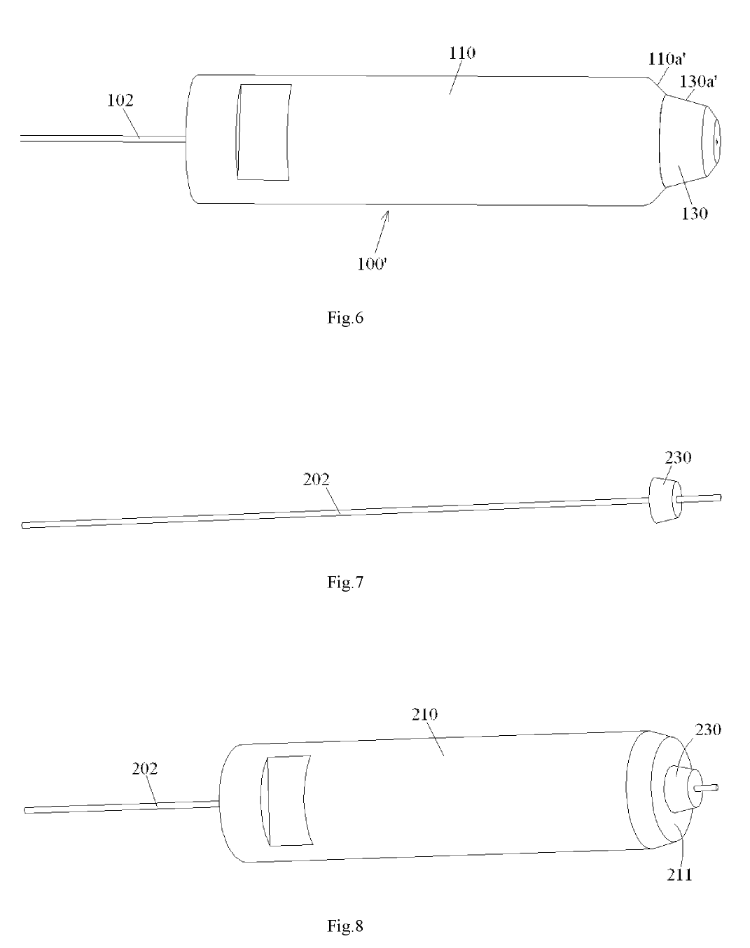

FIG. 6 is a schematic view of another final fiber optic ferrule assembly 100′ formed by cutting and polishing the fiber optic ferrule assembly blank of FIG. 3.

As shown in FIG. 6, the end cover 130 is formed with a first tapered peripheral surface 130a′; the front end of the ferrule body 110 is formed with a second tapered peripheral surface 110a′; and the first tapered peripheral surface 130a′ has a taper different from that of the second tapered peripheral surface 110a′.

### Second Embodiment

FIG. 7 is a schematic view of an optical fiber 202 and a ferrule end portion 230 directly molded on the optical fiber 202 of a fiber optic ferrule assembly 200 according to a second embodiment of the present invention; FIG. 8 is a schematic view of a fiber optic ferrule assembly blank with inserting the optical fiber 202 through a bore of the ferrule body 210 and adhering the ferrule end portion 230 onto the ferrule body 210; FIG. 9 is a schematic view of a final fiber optic ferrule assembly 200 formed by cutting and polishing the fiber optic ferrule assembly blank of FIG. 8.

Hereafter, a method of manufacturing a fiber optic ferrule assembly according to the second embodiment of the present invention will be described with reference to FIGS. 7-9.

Firstly, as shown in FIG. 7, placing the optical fiber 202 into a molding die and injecting a molten material into the molding die, so as to form a ferrule end portion 230 on the optical fiber 202, that is, as shown in FIG. 7, the ferrule end portion 230 is directly over-molded on the optical fiber 202 by injection molding.

Then, as shown in FIG. 8, inserting the optical fiber 202 through a bore formed in a ferrule body 210, and adhering the ferrule end portion 230 onto a front end surface 211 of the ferrule body 210.

Finally, performing subsequent processes, for example, cutting, polishing or applying energy (applying laser or electric arc), on the ferrule body 210 and the optical fiber 202. In this way, a qualified final fiber optic ferrule assembly 200 is formed, as shown in FIG. 9.

In an exemplary embodiment of the present invention, the ferrule end portion 230 is made of a material having a thermal expansion coefficient approximate to that of a material forming the optical fiber 202.

### Third Embodiment

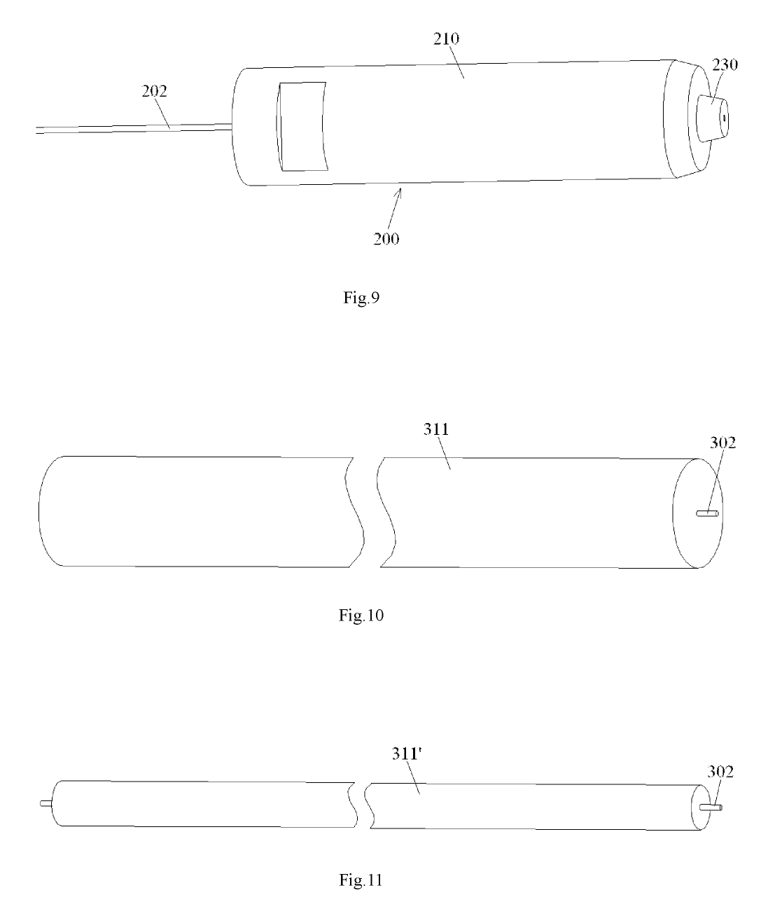

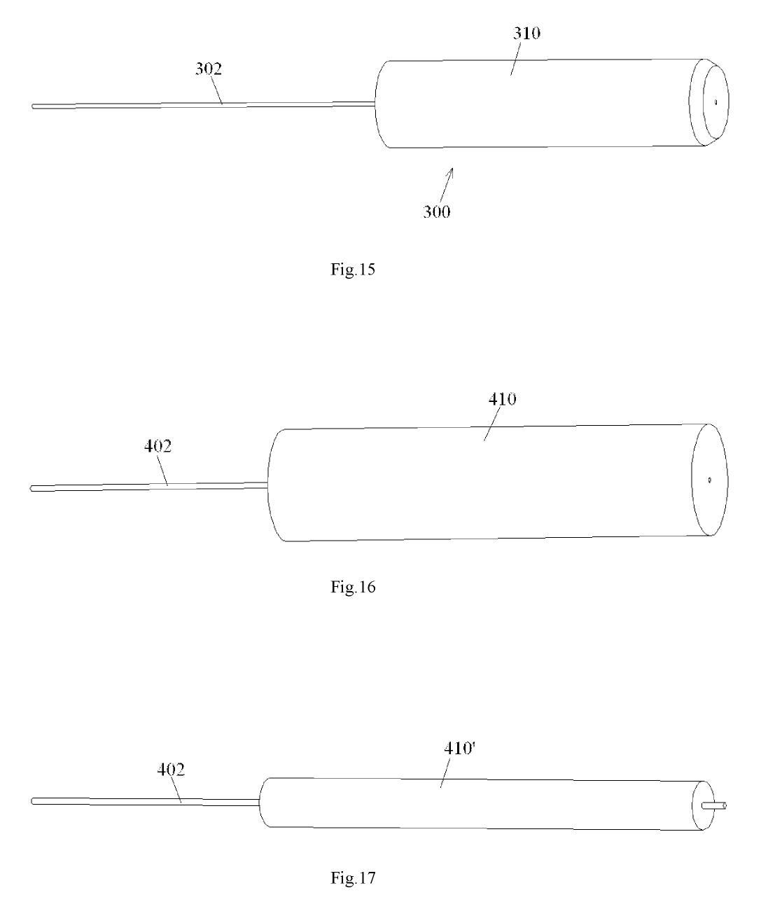

FIG. 10 is a schematic view of a fiber optic ferrule assembly 300 according to a third embodiment of the present invention, in which a preformed body 311 is directly molded on an optical fiber 302; FIG. 13 is a schematic view of a preformed blank section 312 formed by cutting the preformed blank into one or more preformed blank sections 312 with each having a length equal to that of the single fiber optic ferrule assembly; FIG. 14 is a schematic view of the preformed blank section 312 of FIG. 13 with a portion of which removed to expose the optical fiber 302; FIG. 15 is a schematic view of a final fiber optic ferrule assembly 300 formed by cutting and polishing the fiber optic ferrule assembly blank of FIG. 14.

Hereafter, a method of manufacturing a fiber optic ferrule assembly according to the third embodiment of the present invention will be described with reference to FIGS. 10, 13-15.

Firstly, as shown in FIG. 10, directly over-molding a preformed body 311 on the optical fiber 302 by injection molding, so as to obtain a preformed blank having a length larger than that of a single fiber optic ferrule assembly;

Then, as shown in FIG. 13, cutting the preformed blank of FIG. 10 into one or more preformed blank sections 312 with each having a length equal to that of the single fiber optic ferrule assembly;

Then, as shown in FIG. 14, removing a portion of a body of the preformed blank section 312 of FIG. 13 to expose a section of optical fiber 302, and the rest of the body of the preformed blank section 312 is served as the ferrule body 310.

Finally, performing subsequent processes, for example, cutting, polishing or applying energy (applying laser or electric arc), on the ferrule body 310 and the optical fiber 302. In this way, a qualified final fiber optic ferrule assembly 300 is formed, as shown in FIG. 15.

In an exemplary embodiment of the present invention, the ferrule body 310 is made of a material having a thermal expansion coefficient approximate to that of a material forming the optical fiber 302.

In the embodiment shown in FIGS. 10, 13-15, the ferrule body 310 is formed by a single injection molding, but the present disclosure is not limited to this, the ferrule body may be formed by two or more injection molding processes.

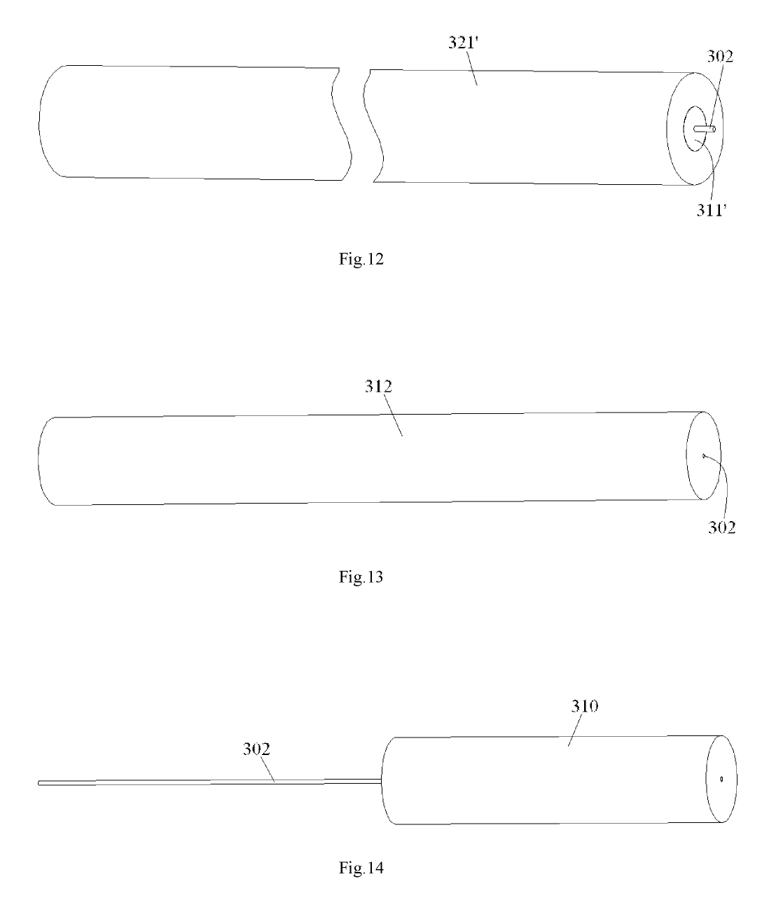

FIG. 11 is a schematic view of a preformed ferrule inner body 311′ directly molded on the optical fiber 302 according to another embodiment of the present invention; FIG. 12 is a schematic view of a preformed ferrule outer body 321′ directly molded on the preformed ferrule inner body 311′ of FIG. 11.

Hereafter, a method of manufacturing a fiber optic ferrule assembly according to an exemplary embodiment of the present invention will be described with reference to FIGS. 11-12.

Firstly, as shown in FIG. 11, directly over-molding a ferrule inner body 311′ on the optical fiber 302 by injection molding, wherein the ferrule inner body 311′ has a length larger than that of a single fiber optic ferrule assembly.

Then, as shown in FIG. 12, directly over-molding a ferrule outer body 321′ on the ferrule inner body 311′ by injection molding, so as to obtain a preformed blank having a length larger than that of the single fiber optic ferrule assembly.

Then, cutting the preformed blank of FIG. 12 into one or more preformed blank sections with each having a length equal to that of the single fiber optic ferrule assembly;

Then, removing a portion of a body of the preformed blank section to expose a section of optical fiber, and the rest of the body of the preformed blank section is served as the ferrule body.

Finally, performing subsequent processes, for example, cutting, polishing or applying energy (applying laser or electric arc), on the ferrule body and the optical fiber. In this way, a qualified final fiber optic ferrule assembly is formed.

In an exemplary embodiment of the present invention, the ferrule inner body 311′ is made of a material having a thermal expansion coefficient approximate to that of a material forming the optical fiber 302.

### Fourth Embodiment

FIG. 16 is a schematic view of a fiber optic ferrule assembly blank according to a fourth embodiment of the present invention, in which a ferrule body 410 is directly molded on an optical fiber 402; FIG. 19 is a schematic view of a final fiber optic ferrule assembly 400 formed by cutting and polishing the fiber optic ferrule assembly blank of FIG. 16.

Hereafter, a method of manufacturing a fiber optic ferrule assembly according to the fourth embodiment of the present invention will be described with reference to FIGS. 16 and 19.

Firstly, as shown in FIG. 16, directly over-molding a ferrule body 410 on the optical fiber 402 by injection molding.

Then, performing subsequent processes, for example, cutting, polishing or applying energy (applying laser or electric arc), on the ferrule body 410 and the optical fiber 402. In this way, a qualified final fiber optic ferrule assembly 400 is formed, as shown in FIG. 19.

In an exemplary embodiment of the present invention, the ferrule body 410 is made of a material having a thermal expansion coefficient approximate to that of a material forming the optical fiber 402.

In the embodiment shown in FIGS. 16 and 19, the ferrule body 410 is formed by a single injection molding, but the present disclosure is not limited to this, the ferrule body may be formed by two or more injection molding processes.

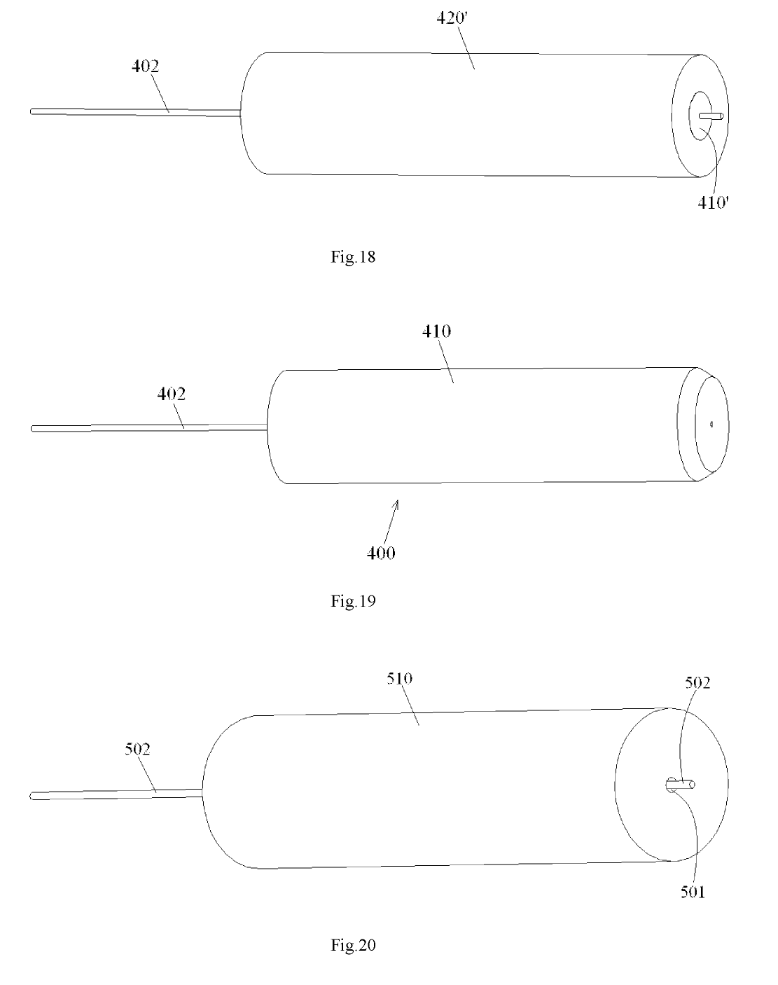

FIG. 17 is a schematic view of a ferrule inner body 410′ directly molded on the optical fiber 402 according to another embodiment of the present invention; FIG. 18 is a schematic view of a ferrule outer body 420′ directly molded on the ferrule inner body 410′ of FIG. 17.

Hereafter, a method of manufacturing a fiber optic ferrule assembly according to an exemplary embodiment of the present invention will be described with reference to FIGS. 17-18.

Firstly, as shown in FIG. 17, directly over-molding a ferrule inner body 410′ on the optical fiber 402 by injection molding.

Then, as shown in FIG. 18, directly over-molding a ferrule outer body 420′ on the ferrule inner body 410′ by injection molding.

Finally, performing subsequent processes, for example, cutting, polishing or applying energy (applying laser or electric arc), on the ferrule body (comprising the ferrule inner body 410′ and the ferrule outer body 420′) and the optical fiber 402. In this way, a qualified final fiber optic ferrule assembly is formed.

In an exemplary embodiment of the present invention, the ferrule inner body 410′ is made of a material having a thermal expansion coefficient approximate to that of a material forming the optical fiber 402.

### Fifth Embodiment

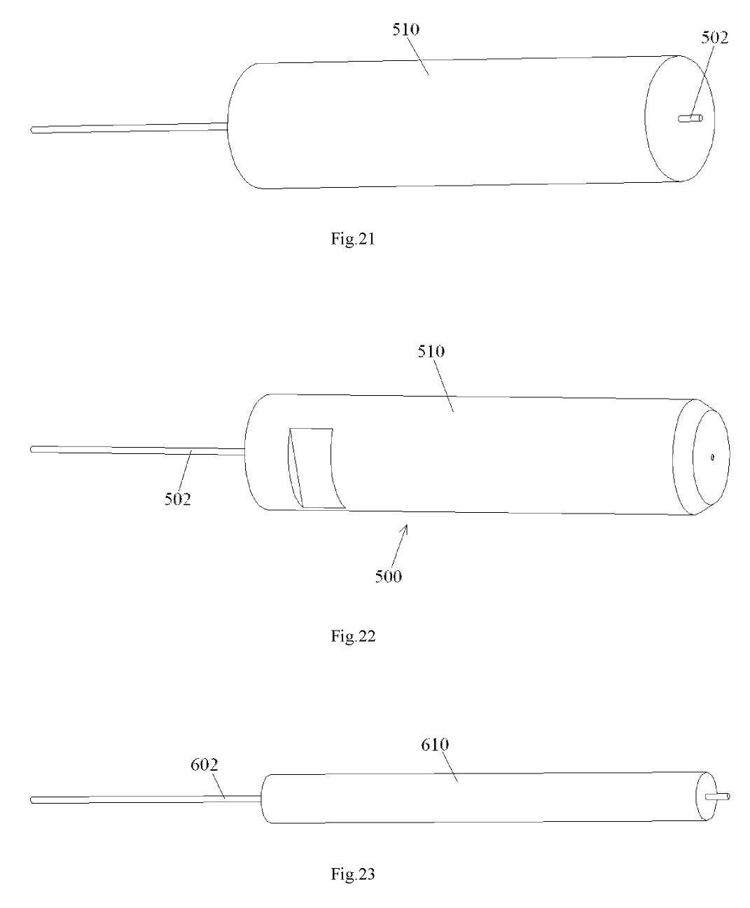

FIG. 20 is a schematic view of a fiber optic ferrule assembly according to a fifth embodiment of the present invention, in which the optical fiber 502 is inserted through a bore 501 formed in the ferrule body 510; FIG. 21 is a schematic view of the fiber optic ferrule assembly of FIG. 20, in which the ferrule body 510 is shrunk on the optical fiber 502; FIG. 22 is a schematic view of a final fiber optic ferrule assembly 500 formed by cutting and polishing the fiber optic ferrule assembly blank of FIG. 21.

Hereafter, a method of manufacturing a fiber optic ferrule assembly according to the fifth embodiment of the present invention will be described with reference to FIGS. 20-22.

Firstly, as shown in FIG. 20, inserting the optical fiber 502 through the bore 501 formed in the ferrule body 510.

Then, as shown in FIG. 21, directly shrinking the ferrule body 510 on the optical fiber 502.

Finally, performing subsequent processes, for example, cutting, polishing or applying energy (applying laser or electric arc), on the ferrule body 510 and the optical fiber 502. In this way, a qualified final fiber optic ferrule assembly 500 is formed, as shown in FIG. 22.

In an exemplary embodiment of the present invention, the ferrule body 510 may be made of heat shrinkable material or cold shrinkage material. In this way, after the optical fiber 502 is inserted through the bore 501 of the ferrule body 510, the ferrule body 510 may be directly shrunk on the optical fiber 502 by heating or cooling the ferrule body 510.

In an exemplary embodiment of the present invention, before shrinking the ferrule body 510, the diameter of the bore 501 of the ferrule body 510 is much larger than the diameter of the optical fiber 502. In this way, the optical fiber 502 may be smoothly inserted through the bore 501 of the ferrule body 510.

In an exemplary embodiment of the present invention, the ferrule body 510 is made of a material having a thermal expansion coefficient approximate to that of a material forming the optical fiber 502.

### Sixth Embodiment

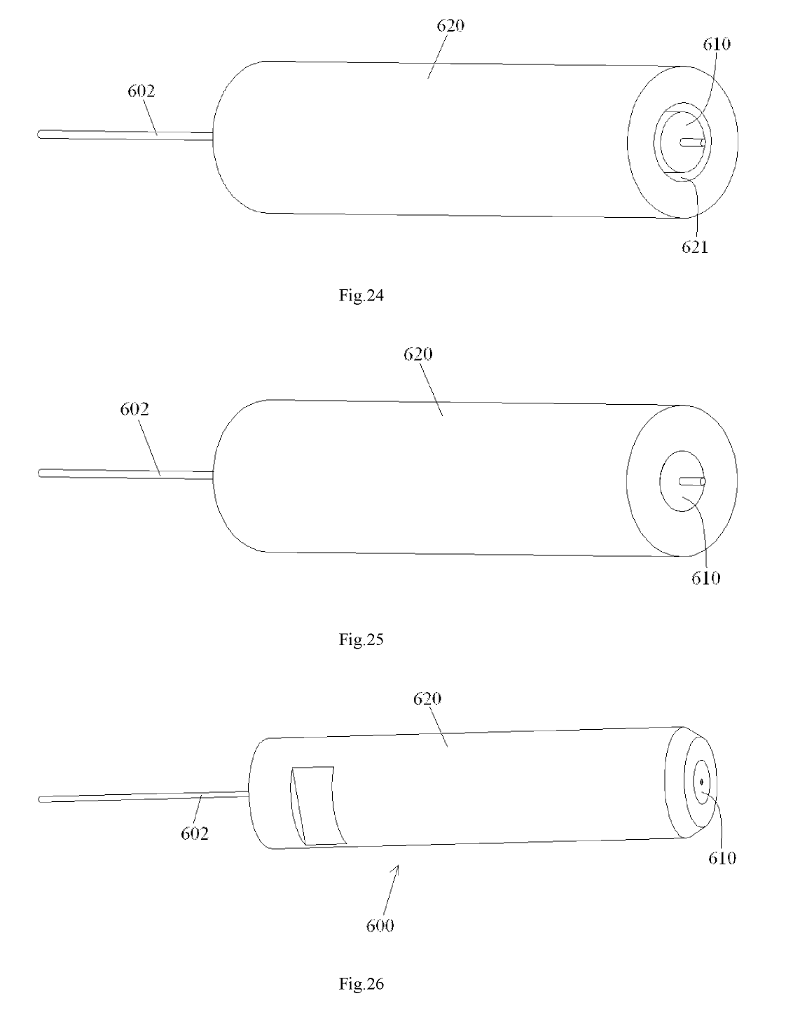

FIG. 23 is a schematic view of a fiber optic ferrule assembly according to a sixth embodiment of the present invention, in which a ferrule inner body 610 is directly molded on an optical fiber 602; FIG. 24 is a schematic view showing the ferrule inner body 610 and the optical fiber 602 inserted through a hole 621 formed in a ferrule outer body 620; FIG. 25 is a schematic view showing the ferrule outer body 620 shrunk on the ferrule inner body 610; and FIG. 26 is a schematic view of a final fiber optic ferrule assembly 600 formed by cutting and polishing the fiber optic ferrule assembly blank of FIG. 25.

Hereafter, a method of manufacturing a fiber optic ferrule assembly according to the sixth embodiment of the present invention will be described with reference to FIGS. 23-26.

Firstly, as shown in FIG. 23, directly over-molding a ferrule inner body 610 on an optical fiber 602 by injection molding.

Then, as shown in FIG. 24, inserting the ferrule inner body 610 and the optical fiber 602 through a hole 621 formed in a ferrule outer body 620.

Then, as shown in FIG. 25, directly shrinking the ferrule outer body 620 on the ferrule inner body 610.

Finally, performing subsequent processes, for example, cutting, polishing or applying energy (applying laser or electric arc), on the ferrule outer body 620 and the optical fiber 602. In this way, a qualified final fiber optic ferrule assembly 600 is formed, as shown in FIG. 26.

In an exemplary embodiment of the present invention, the ferrule outer body 620 may be made of heat shrinkable material or cold material shrinkage. In this way, after the ferrule inner body 610 is inserted through the hole 621 of the ferrule outer body 620, the ferrule outer body 620 may be directly shrunk on the ferrule inner body 610 by heating or cooling the ferrule outer body 620.

In an exemplary embodiment of the present invention, before shrinking the ferrule outer body 620, the hole 621 of the ferrule outer body 620 has a diameter larger than that of the ferrule inner body 610. In this way, the ferrule inner body 610 may be smoothly inserted into the hole 621 of the ferrule outer body 620.

In an exemplary embodiment of the present invention, the ferrule inner body 610 is made of a material having a thermal expansion coefficient approximate to that of a material forming the optical fiber 602.

In the embodiment shown in FIG. 25, a front end surface of the ferrule inner body 610 is flush with a front end surface of the ferrule outer body 620. But the present disclosure is not limited to this, for example, a front end surface of the ferrule inner body may be protruded from a front end surface of the ferrule outer body, or a front end surface of the ferrule inner body may be recessed into the ferrule outer body.

### Seventh Embodiment

Although it is not shown, hereafter, a method of manufacturing a fiber optic ferrule assembly according to a seventh embodiment of the present invention will be described.

Firstly, inserting an optical fiber through a bore formed in a ferrule inner body.

Then, directly shrinking the ferrule inner body on the optical fiber.

Then, directly over-molding a ferrule outer body on the ferrule inner body by injection molding.

Finally, performing subsequent processes, for example, cutting, polishing or applying energy (applying laser or electric arc), on the ferrule outer body and the optical fiber. In this way, a qualified final fiber optic ferrule assembly is formed.

In an exemplary embodiment of the present invention, the ferrule inner body may be made of heat shrinkable material or cold material shrinkage. As a result, after the optical fiber is inserted through the bore of the ferrule inner body, the ferrule inner body may be directly shrunk on the optical fiber by heating or cooling the ferrule inner body.

In an exemplary embodiment of the present invention, before shrinking the ferrule inner body, the bore of the ferrule inner body has a diameter larger than that of the optical fiber. In this way, the optical fiber may be smoothly inserted through the bore of the ferrule inner body.

In an exemplary embodiment of the present invention, the ferrule inner body is made of a material having a thermal expansion coefficient approximate to that of a material forming the optical fiber.

Although the fiber optic ferrule assembly described in above embodiments is a single fiber optic ferrule, the present invention is not limited to this. For example, the fiber optic ferrule assembly may be a multi-fiber optic ferrule, a single mode fiber optic ferrule or a multi-mode fiber optic ferrule.

According to another exemplary embodiment of the present invention, there is provided a fiber optic connector comprising a housing and the above fiber optic ferrule assembly mounted in the housing.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A fiber optic ferrule assembly, comprising:
a ferrule; and
an optical fiber received in the ferrule,
wherein the ferrule and the optical fiber are directly joined together, so as to fix the optical fiber in the ferrule.

2. The fiber optic ferrule assembly according to claim 1, wherein
at least a part of the ferrule is directly over-molded on the optical fiber by injection molding, so that the ferrule and the optical fiber are directly joined together.

3. The fiber optic ferrule assembly according to claim 2,
wherein the ferrule comprises:
a ferrule body having an end projection formed on a front end surface thereof; and
an end cover directly over-molded on the end projection and the optical fiber protruding from a front end of the end projection by injection molding.

4. The fiber optic ferrule assembly according to claim 3,
wherein a bore is formed in the ferrule body, and the optical fiber is inserted through the bore and protrudes from the front end of the end projection.

5. The fiber optic ferrule assembly according to claim 3,
wherein at least one circumferential groove is formed in the end projection; and
wherein the end projection is covered by the end cover, and a portion of the end cover is embedded into the circumferential groove, so as to secure the end cover onto the end projection and prevent the end cover from being disengaged from the end projection.

6. The fiber optic ferrule assembly according to claim 5,
wherein at least one axial groove is formed in the end projection; and
wherein a portion of the end cover is embedded into the axial groove, so as to prevent the end cover from being rotated with respect to the end projection.

7. The fiber optic ferrule assembly according to claim 3, wherein the ferrule body is made of ceramic or plastic.

8. The fiber optic ferrule assembly according to claim 3,
wherein the end cover is made of a material having a thermal expansion coefficient approximate to that of a material forming the optical fiber.

9. The fiber optic ferrule assembly according to claim 3,
wherein the end cover is formed with a first tapered peripheral surface;
wherein the front end of the ferrule body is formed with a second tapered peripheral surface; and
wherein the first tapered peripheral surface has a taper equal to that of the second tapered peripheral surface.

10. The fiber optic ferrule assembly according to claim 3,
wherein the end cover is formed with a first tapered peripheral surface;
wherein the front end of the ferrule body is formed with a second tapered peripheral surface; and
wherein the first tapered peripheral surface has a taper different from that of the second tapered peripheral surface.

11. The fiber optic ferrule assembly according to claim 2,
wherein the ferrule comprises:
a ferrule body; and
a ferrule end portion adhered to a front end surface of the ferrule body,
wherein the ferrule end portion is directly over-molded on the optical fiber by injection molding, and the optical fiber is inserted through a bore formed in the ferrule body.

12. The fiber optic ferrule assembly according to claim 11,
wherein the ferrule end portion is made of a material having a thermal expansion coefficient approximate to that of a material forming the optical fiber.

13. The fiber optic ferrule assembly according to claim 2, wherein the entire ferrule is directly over-molded on the optical fiber by injection molding.

14. The fiber optic ferrule assembly according to claim 13,
wherein the ferrule is made of a material having a thermal expansion coefficient approximate to that of a material forming the optical fiber.

15. The fiber optic ferrule assembly according to claim 2,
wherein the ferrule comprises:
an inner body directly over-molded on the optical fiber by injection molding; and
an outer body directly over-molded on the inner body by injection molding.

16. The fiber optic ferrule assembly according to claim 15,
wherein the inner body is made of a material having a thermal expansion coefficient approximate to that of a material forming the optical fiber.

17. The fiber optic ferrule assembly according to claim 1,
wherein at least a part of the ferrule is directly shrunk on the optical fiber, so that the ferrule and the optical fiber are directly joined together.

18. The fiber optic ferrule assembly according to claim 17, wherein the entire ferrule is directly shrunk on the optical fiber.

19. The fiber optic ferrule assembly according to claim 18,
wherein the ferrule is made of a material having a thermal expansion coefficient approximate to that of a material forming the optical fiber.

20. The fiber optic ferrule assembly according to claim 2,
wherein the ferrule comprises:
an inner body directly over-molded on the optical fiber by injection molding; and
an outer body directly shrunk on the inner body.

21. The fiber optic ferrule assembly according to claim 20,
wherein the inner body is made of a material having a thermal expansion coefficient approximate to that of a material forming the optical fiber.

22. The fiber optic ferrule assembly according to claim 1,
wherein the ferrule is a single fiber optic ferrule, a multi-fiber optic ferrule, a single mode fiber optic ferrule or a multi-mode fiber optic ferrule.

23. A method of manufacturing a fiber optic ferrule assembly, comprising steps of:
S100: directly over-molding at least a part of a ferrule onto an optical fiber by injection molding, so that the ferrule and the optical fiber are directly joined together to form the fiber optic ferrule assembly.

24. The method according to claim 23, wherein the step S100 comprises:
S111: forming a ferrule body having a bore therein and an end projection on a front end surface thereof;
S112: inserting an optical fiber into the bore of the ferrule body until the optical fiber is protruded from a front end of the end projection;
S113: directly over-molding an end cover on the end projection and the optical fiber protruding from the front end of the end projection by injection molding; and
S114: processing the ferrule and the optical fiber.

25. The method according to claim 24,
wherein at least one circumferential groove is formed in the end projection; and
wherein the end projection is covered by the end cover, and a portion of the end cover is embedded into the circumferential groove, so as to secure the end cover onto the end projection and prevent the end cover from being disengaged from the end projection.

26. The method according to claim 25,
wherein at least one axial groove is formed in the end projection; and
wherein a portion of the end cover is embedded into the axial groove, so as to prevent the end cover from being rotated with respect to the end projection.

27. The method according to claim 24, wherein the ferrule body is made of ceramic or plastic.

28. The method according to claim 24, wherein the end cover is made of a material having a thermal expansion coefficient approximate to that of a material forming the optical fiber.

29. The method according to claim 24,
wherein the end cover is formed with a first tapered peripheral surface;
wherein the front end of the ferrule body is formed with a second tapered peripheral surface; and
wherein the first tapered peripheral surface has a taper equal to that of the second tapered peripheral surface.

30. The method according to claim 24,
wherein the end cover is formed with a first tapered peripheral surface;
wherein the front end of the ferrule body is formed with a second tapered peripheral surface; and
wherein the first tapered peripheral surface has a taper different from that of the second tapered peripheral surface.

31. The method according to claim 23, wherein the step S100 comprises:
S121: directly over-molding a ferrule end portion on the optical fiber by injection molding;
S122: inserting the optical fiber through a bore formed in a ferrule body, and adhering the ferrule end portion onto a front end surface of the ferrule body; and
S123: processing the ferrule and the optical fiber.

32. The method according to claim 31,
wherein the ferrule end portion is made of a material having a thermal expansion coefficient approximate to that of a material forming the optical fiber.

33. The method according to claim 23, wherein the step S100 comprises:
S131: directly over-molding a preformed body on the optical fiber by injection molding, so as to obtain a preformed blank having a length larger than that of a single fiber optic ferrule assembly;
S132: cutting the preformed blank into one or more preformed blank sections with each having a length equal to that of the single fiber optic ferrule assembly;
S133: removing a portion of a body of the preformed blank section to expose a section of optical fiber, and using the rest of the body of the preformed blank section as a ferrule body; and
S134: processing the ferrule body and the optical fiber.

34. The method according to claim 33,
wherein the ferrule body is made of a material having a thermal expansion coefficient approximate to that of a material forming the optical fiber.

35. The method according to claim 33, wherein the step 5131 comprises:
S1311: directly over-molding a preformed inner body on the optical fiber by injection molding; and
S1312: directly over-molding a preformed outer body on the preformed inner body by injection molding, so as to obtain the preformed blank having a length larger than that of the single fiber optic ferrule assembly.

36. The method according to claim 35,
wherein the preformed inner body is made of a material having a thermal expansion coefficient approximate to that of a material forming the optical fiber.

37. The method according to claim 23, wherein the step S100 comprises:
S141: directly over-molding a ferrule body on the optical fiber by injection molding; and
S142: processing the ferrule body and the optical fiber.

38. The method according to claim 37,
wherein the ferrule body is made of a material having a thermal expansion coefficient approximate to that of a material forming the optical fiber.

39. The method according to claim 37, wherein the step 5141 comprises:
S1411: directly over-molding a ferrule inner body on the optical fiber by injection molding; and
S1412: directly over-molding a ferrule outer body on the ferrule inner body by injection molding.

40. The method according to claim 39,
wherein the ferrule inner body is made of a material having a thermal expansion coefficient approximate to that of a material forming the optical fiber.

41. A method of manufacturing a fiber optic ferrule assembly, comprising steps of:
S200: directly shrinking at least a part of a ferrule on an optical fiber, so that the ferrule and the optical fiber are directly joined together to form the fiber optic ferrule assembly.

42. The method according to claim 41, wherein the step 5200 comprises:
S211: inserting the optical fiber through a bore formed in a ferrule body;
S212: directly shrinking the ferrule body on the optical fiber; and
S213: processing the ferrule body and the optical fiber.

43. The method according to claim 42, wherein
the bore of the ferrule body has a diameter larger than that of the optical fiber before shrinking the ferrule body.

44. The method according to claim 42,
wherein the ferrule body is made of a material having a thermal expansion coefficient approximate to that of a material forming the optical fiber.

45. A method of manufacturing a fiber optic ferrule assembly, comprising steps of:
S311: directly over-molding a ferrule inner body on an optical fiber by injection molding;
S312: inserting the ferrule inner body and the optical fiber through a hole formed in a ferrule outer body;
S313: directly shrinking the ferrule outer body on the ferrule inner body; and
S314: processing the ferrule and the optical fiber.

46. The method according to claim 45,
wherein a front end surface of the ferrule inner body is flush with a front end surface of the ferrule outer body; or
wherein a front end surface of the ferrule inner body is protruded from a front end surface of the ferrule outer body; or
wherein a front end surface of the ferrule inner body is recessed into the ferrule outer body.

47. The method according to claim 45, wherein
the hole of the ferrule outer body has a diameter larger than an outer diameter of the ferrule inner body before shrinking the ferrule outer body.

48. The method according to claim 45,
wherein the ferrule inner body is made of a material having a thermal expansion coefficient approximate to that of a material forming the optical fiber.

49. A method of manufacturing a fiber optic ferrule assembly, comprising steps of:
S321: inserting an optical fiber through a bore formed in a ferrule inner body;
S322: directly shrinking the ferrule inner body on the optical fiber;
S323: directly over-molding a ferrule outer body on the ferrule inner body by injection molding; and
S324: processing the ferrule and the optical fiber.

50. The method according to claim 49, wherein
the bore of the ferrule inner body has a diameter larger than that of the optical fiber before shrinking the ferrule inner body.

51. The method according to claim 49,
wherein the ferrule inner body is made of a material having a thermal expansion coefficient approximate to that of a material forming the optical fiber.

52. The method according to claim 23,
wherein the ferrule is a single fiber optic ferrule, a multi-fiber optic ferrule, a single mode fiber optic ferrule or a multi-mode fiber optic ferrule.

53. A fiber optic connector, comprising:
a housing; and
the fiber optic ferrule assembly, according to any one of claims 1-22 or made by the method according to any one of claims 23-52, mounted in the housing.
